(19) United States
(12) Patent Application Publication
(10) Pub. No.: US 2024/0217732 A1
(43) Pub. Date: Jul. 4, 2024

(54) ELECTRIC TAILGATE FOR ELECTRIC REFUSE VEHICLE

(71) Applicant: Oshkosh Corporation, Oshkosh, WI (US)

(72) Inventors: Derek A. Wente, Oshkosh, WI (US); Andrew Kotloski, Oshkosh, WI (US); Caleb Binder, Oshkosh, WI (US); Martin J. Schimke, Oshkosh, WI (US); Jacob Solberg, Oshkosh, WI (US)

(21) Appl. No.: 18/399,526

(22) Filed: Dec. 28, 2023

Related U.S. Application Data
(60) Provisional application No. 63/435,973, filed on Dec. 29, 2022.

(51) Int. Cl. B65F 3/02; E05F 15/622; E05F 15/627; E05F 15/63

(52) U.S. Cl. CPC B65F 3/02; E05F 15/622; E05F 15/627; E05F 15/63; B65F 2003/0279; E05Y 2201/22; E05Y 2201/232; E05Y 2201/41; E05Y 2201/422; E05Y 2201/434; E05Y 2201/474; E05Y 2201/484; E05Y 2201/624; E05Y 2900/518; E05Y 2900/546

(57) ABSTRACT

A refuse vehicle including a chassis, a body coupled with the chassis, a tailgate, an electric lock, and an electric tailgate actuator assembly. The tailgate is coupled with a rear of the body and is transitionable between a first position and a second position. The electric tailgate actuator assembly configured to transition the tailgate between the first position and the second position.

### CROSS-REFERENCE TO RELATED PATENT APPLICATIONS

This application claims the benefit of and priority to U.S. Provisional Patent Application No. 63/435,973, filed on Dec. 29, 2022, the entirety of which is incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One implementation of the present disclosure is a refuse vehicle. The refuse vehicle can include a chassis. The refuse vehicle can also include a body. The body can be coupled with the chassis. The body can also define a refuse compartment. The refuse vehicle can also include a tailgate. The tailgate can be coupled with a rear of the body. The tailgate can be transitionable between a first position to limit access to the refuse compartment and a second position to allow access to the refuse compartment. The refuse can also include an electric tailgate actuator assembly. The electric tailgate actuator assembly can include a first linkage extending from a first point on the body to a first point on the tailgate. The electric tailgate actuator assembly can also include a second linkage extending from a second point on the body to a second point on the tailgate. The electric tailgate actuator assembly can also include an electric motor and a spring mechanism. The electric motor and the spring mechanism can drive at least one of the first linkage or the second linkage to transition the tailgate between the first position and the second position. The refuse vehicle can also include a lock mechanism. The lock mechanism can lock the tailgate in the first position. The lock mechanism can be released as the tailgate rotates from the first position to the second position. The lock mechanism can be engaged at a final stage as the tailgate rotates from the second position to the first position.

Another implementation of the present disclosure is a refuse vehicle. The refuse vehicle can include a chassis. The refuse vehicle can also include a body. The body can be coupled with the chassis. The body can also define a refuse compartment. The refuse vehicle can also include a tailgate. The tailgate can be coupled with a rear of the body. The tailgate can be transitionable between a first position to limit access to the refuse compartment and a second position to allow access to the refuse compartment. The refuse vehicle can also include a fully electric tailgate actuator assembly. The fully electric tailgate actuator assembly can include a first linkage extending from a first point on the body to a first point on the tailgate. The fully electric tailgate actuator assembly can also include a second linkage extending from a second point on the body to a second point on the tailgate. The fully electric tailgate actuator assembly can also include an electric motor. The electric motor can drive at least one of the first linkage or the second linkage to transition the tailgate between the first position and the second position.

Another implementation of the present disclosure is a refuse vehicle. The refuse vehicle can include a chassis. The refuse vehicle can also include a body. The body can be coupled with the chassis. The refuse vehicle can also include a tailgate. The tailgate can be coupled with the body. At least a portion of the tailgate can be transitionable between a first position and a second position. The refuse vehicle can also include an actuator assembly. The actuator assembly can include a first linkage extending from a first point on the body to a first point on the tailgate. The actuator assembly can also include a second linkage extending from a second point on the body to a second point on the tailgate. The actuator assembly can also include an electric motor configured to drive at least one of the first linkage or the second linkage to transition the tailgate between the first position and the second position.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a refuse vehicle including a tailgate transitionable between a first position and a second position, according to an exemplary embodiment.

FIG. 2 is a tailgate of the refuse vehicle of FIG. 1 having an electric mechanism for transitioning a tailgate between a first position and a second position, according to an exemplary embodiment.

FIG. 3 is the tailgate of FIG. 2 having electric locking mechanisms, according to an exemplary embodiment.

FIG. 4 is a tailgate of the refuse vehicle of FIG. 1 having a mechanism for transitioning a tailgate between a first position and a second position, according to an exemplary embodiment.

FIG. 5 is a tailgate of the refuse vehicle of FIG. 1 having a mechanism for transitioning a tailgate between a first position and a second position, according to an exemplary embodiment.

FIG. 6A is a perspective view of a portion of the refuse vehicle of FIG. 1 including side-mounted electric actuators for transitioning the tailgate between the first position and the second position, according to an exemplary embodiment.

FIG. 6B is a perspective view of a portion of the refuse vehicle of FIG. 1 including top-mounted electric actuators for transitioning the tailgate between the first position and the second position when the tailgate is in the first position, according to an exemplary embodiment.

FIG. 6C is a perspective view of a portion of the refuse vehicle of FIG. 6B including the top-mounted electric actuators when the tailgate is in the second position, according to an exemplary embodiment.

FIG. 6D is a perspective view of a portion of the refuse vehicle of FIG. 1 including side-mounted electric actuators for transitioning the tailgate between the first position and the second position, according to an exemplary embodiment.

FIG. 7A is a side view of a portion of the refuse vehicle of FIG. 1 including a cable lift mechanism with a telescoping pulley to transition the tailgate between the first position and the second position when the tailgate is in the first position, according to an exemplary embodiment.

FIG. 7B is a side view of a portion of the refuse vehicle of FIG. 7A including the cable lift mechanism when the tailgate is in the second position, according to an exemplary embodiment.

FIG. 7C is a top right view of a portion of the refuse vehicle of FIG. 1 including a cable lift mechanism with a telescoping pulley to transition the tailgate between the first position and the second position when the tailgate is in the first position, according to an exemplary embodiment.

FIG. 8A is a portion of the refuse vehicle of FIG. 1 including an eccentric gearing mechanism to transition the tailgate between the first position and the second position, according to an exemplary embodiment.

FIG. 8B is a side view of a portion of the refuse vehicle of FIG. 1 including the eccentric gearing mechanism of FIG. 8A when the tailgate is in the second position, according to an exemplary embodiment.

FIG. 9A is a perspective view of a portion of the refuse vehicle of FIG. 1 including a side hinge mechanism when the tailgate is in the first position, according to an exemplary embodiment.

FIG. 9B is a perspective view of a portion of the refuse vehicle of FIG. 1 including the side hinge mechanism of FIG. 9A when the tailgate is in the second position, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, an electric tailgate for a refuse vehicle is disclosed herein. The electric tailgate of the present disclosure provides many advantages over conventional systems. The electric tailgate may include one or more electric components to replace traditional hydraulic components, such as hydraulic actuators. Hydraulic actuators use hydraulic fluid, which is prone to leaking and environmentally harmful. Therefore, electric components are desirable. Furthermore, hydraulic components require a system to pressurize and distribute the hydraulic fluid requiring excess hosing, pumps and reservoirs, making them more complex and difficult to service. Electric components, such as an electric motor, are easily serviceable and modular such that they can be readily swapped for one another, decreasing maintenance cost and complexity. The electric tailgate may include electronic locking mechanisms to lock and unlock the tailgate without the need for an operator to manually engage a locking mechanism. Alternatively or additionally, the electric tailgate may include one or more electric components coupled to, or integrated with, traditional components, such as a hydraulic actuator. For example, an electric tailgate may include an electronically controlled hydraulic pump swash plate as a throttling element for a hydraulic system.

The refuse vehicle can include a body, a chassis, and a tailgate. The body can include or define an inner or storage volume for storing, loading, and unloading of refuse. The tailgate may be hingedly coupled (e.g., at a top rearmost edge of the body, along a vertical axis that extends along a vertical member of the body) with the body, or translatable relative to the body. The tailgate is transitionable between a first position (e.g., a sealed position, a closed position) to prevent or limit access to the storage volume of the body and a second position (e.g., an open position, an access position, etc.) to allow or facilitate access to the storage volume of the body (e.g., through a rear opening in the body). Various fully or hybrid electric systems for transitioning the tailgate between the first position/state and the second position/state are described herein.

The refuse vehicle can also include a locking system for preventing movement, rotation, pivoting, translation, etc., of the tailgate relative to the body. The locking system may be transitionable (e.g., manually, through operation of one or more electric motors, linear electric actuators, or other electrical devices) between a disengaged or an unlocked state and an engaged or locked state. When the locking system is transitioned into the locked state, movement of the tailgate may be limited. For example, the locking system may limit or prevent the tailgate from transitioning out of the first position and into the second position. Various locking systems, apparatuses, assemblies, mechanisms, etc., are described herein.

### Overall Vehicle

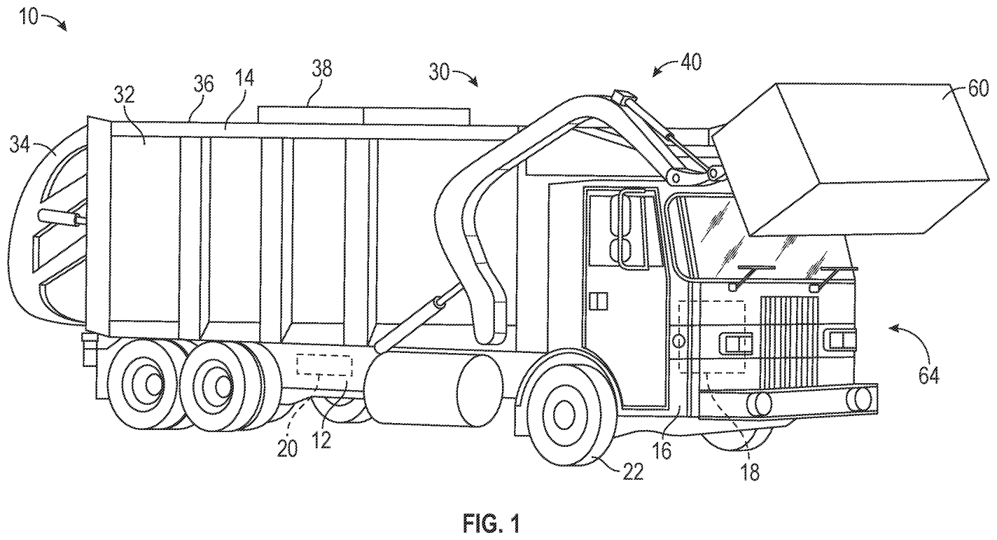

As shown in FIG. 1, a vehicle, shown as refuse vehicle 10 (e.g., a garbage truck, a waste collection truck, a sanitation truck, a recycling truck, etc.), is configured as a front-loading refuse truck. In other embodiments, the refuse vehicle 10 is configured as a side-loading refuse truck or a rear-loading refuse truck. In still other embodiments, the vehicle is another type of vehicle (e.g., a skid-loader, a telehandler, a plow truck, a boom lift, etc.). As shown in FIG. 1, the refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, actuator controls, a user interface, switches, buttons, dials, etc.).

As shown in FIG. 1, the refuse vehicle 10 includes a prime mover, shown as electric motor 18, and an energy system, shown as energy storage and/or generation system 20. In other embodiments, the prime mover is or includes an internal combustion engine. According to the exemplary embodiment shown in FIG. 1, the electric motor 18 is coupled to the frame 12 at a position beneath the cab 16. The electric motor 18 is configured to provide power to a plurality of tractive elements, shown as wheels 22 (e.g., via a drive shaft, axles, etc.). In other embodiments, the electric motor 18 is otherwise positioned and/or the refuse vehicle 10 includes a plurality of electric motors to facilitate independently driving one or more of the wheels 22. In still other embodiments, the electric motor 18 or a secondary electric motor is coupled to and configured to drive a hydraulic system that powers hydraulic actuators. According to the exemplary embodiment shown in FIG. 1, the energy storage and/or generation system 20 is coupled to the frame 12 beneath the body 14. In other embodiments, the energy storage and/or generation system 20 is otherwise positioned (e.g., within a tailgate of the refuse vehicle 10, beneath the cab 16, along the top of the body 14, within the body 14, etc.).

According to an exemplary embodiment, the energy storage and/or generation system 20 is configured to (a) receive, generate, and/or store power and (b) provide electric power to (i) the electric motor 18 to drive the wheels 22, (ii) electric actuators of the refuse vehicle 10 to facilitate operation thereof (e.g., lift actuators, tailgate actuators, packer actuators, grabber actuators, etc.), and/or (iii) other electrically operated accessories of the refuse vehicle 10 (e.g., displays, lights, etc.). The energy storage and/or generation system 20 may include one or more rechargeable batteries (e.g., lithium-ion batteries, nickel-metal hydride batteries, lithium-ion polymer batteries, lead-acid batteries, nickel-cadmium batteries, etc.), capacitors, solar cells, generators, power buses, etc. In one embodiment, the refuse vehicle 10 is a completely electric refuse vehicle. In other embodiments, the refuse vehicle 10 includes an internal combustion generator that utilizes one or more fuels (e.g., gasoline, diesel, propane, natural gas, hydrogen, etc.) to generate electricity to charge the energy storage and/or generation system 20, power the electric motor 18, power the electric actuators, and/or power the other electrically operated accessories (e.g., a hybrid refuse vehicle, etc.). For example, the refuse vehicle 10 may have an internal combustion engine augmented by the electric motor 18 to cooperatively provide power to the wheels 22. The energy storage and/or generation system 20 may thereby be charged via an on-board generator (e.g., an internal combustion generator, a solar panel system, etc.), from an external power source (e.g., overhead power lines, mains power source through a charging input, etc.), and/or via a power regenerative braking system, and provide power to the electrically operated systems of the refuse vehicle 10. In some embodiments, the energy storage and/or generation system 20 includes a heat management system (e.g., liquid cooling, heat exchanger, air cooling, etc.).

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted (e.g., by a packer system, etc.). The refuse compartment 30 may provide temporary storage for refuse during transport to a waste disposal site and/or a recycling facility. In some embodiments, at least a portion of the body 14 and the refuse compartment 30 extend above or in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (e.g., refuse is loaded into a position of the refuse compartment 30 behind the cab 16 and stored in a position further toward the rear of the refuse compartment 30, a front-loading refuse vehicle, a side-loading refuse vehicle, etc.). In other embodiments, the storage volume is positioned between the hopper volume and the cab 16 (e.g., a rear-loading refuse vehicle, etc.).

As shown in FIG. 1, the refuse vehicle 10 includes a lift mechanism/system (e.g., a front-loading lift assembly, etc.), shown as lift assembly 40, coupled to the front end of the body 14. In other embodiments, the lift assembly 40 extends rearward of the body 14 (e.g., a rear-loading refuse vehicle, etc.). In still other embodiments, the lift assembly 40 extends from a side of the body 14 (e.g., a side-loading refuse vehicle, etc.). As shown in FIG. 1, the lift assembly 40 is configured to engage a container (e.g., a residential trash receptacle, a commercial trash receptacle, a container having a robotic grabber arm, etc.), shown as refuse container 60. The lift assembly 40 may include various actuators (e.g., electric actuators, hydraulic actuators, pneumatic actuators, etc.) to facilitate engaging the refuse container 60, lifting the refuse container 60, and tipping refuse out of the refuse container 60 into the hopper volume of the refuse compartment 30 through an opening in the cover 36 or through the tailgate 34. The lift assembly 40 may thereafter return the empty refuse container 60 to the ground. According to an exemplary embodiment, a door, shown as top door 38, is movably coupled along the cover 36 to seal the opening thereby preventing refuse from escaping the refuse compartment 30 (e.g., due to wind, bumps in the road, etc.).

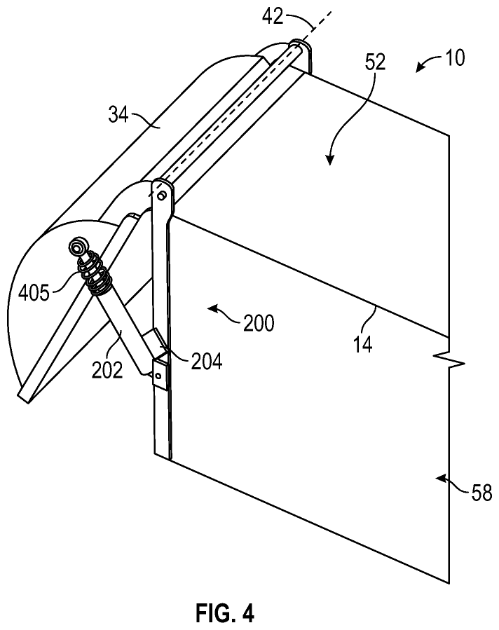

The tailgate 34 may be configured to transition between a first position, a closed position, a sealed position, etc., (e.g., a first state or first position as shown in FIG. 1) and a second position, an open position, an open position, an open state, an open configuration, etc. (e.g., as shown in FIG. 4). The tailgate 34 can be operated to transition between the first position and the second position using any of multiple driving mechanisms, assembles, apparatuses, etc., as described herein. In some embodiments, the driving mechanisms for transitioning the tailgate 34 between the first position and the second position are fully electric systems (e.g., including various linear electric actuators, electric motors, gearing assemblies, etc.). In other embodiments, the driving mechanisms for transitioning the tailgate 34 between the first position and the second position are hybrid systems including one or more primary electric movers (e.g., linear electric actuators, electric motors), and other motive systems that operate based on a different principle (e.g., a different source of energy, such as hydraulic, pneumatic, mechanical, etc.). In some embodiments, the tailgate 34 is transitionable between the first position and the second position by pivoting relative to refuse compartment 30. When the tailgate 34 is in the first position, the refuse compartment 30 may be accessed, while when the tailgate 34 is in the second position, access to the refuse compartment 30 may be restricted, prevented, or limited. For example, the tailgate 34 can be hingedly coupled at a top portion, a bottom portion, a right portion, a left portion, etc., of refuse compartment 30 and may pivot or rotate relative to the hinged coupling to facilitate selective access to refuse compartment 30. In some embodiments, the tailgate 34 is transitionable between the first position and the second position in response to a user input (e.g., a user request) that is provided by an operator via a human machine interface (HMI) on refuse vehicle 10.

### Tailgate

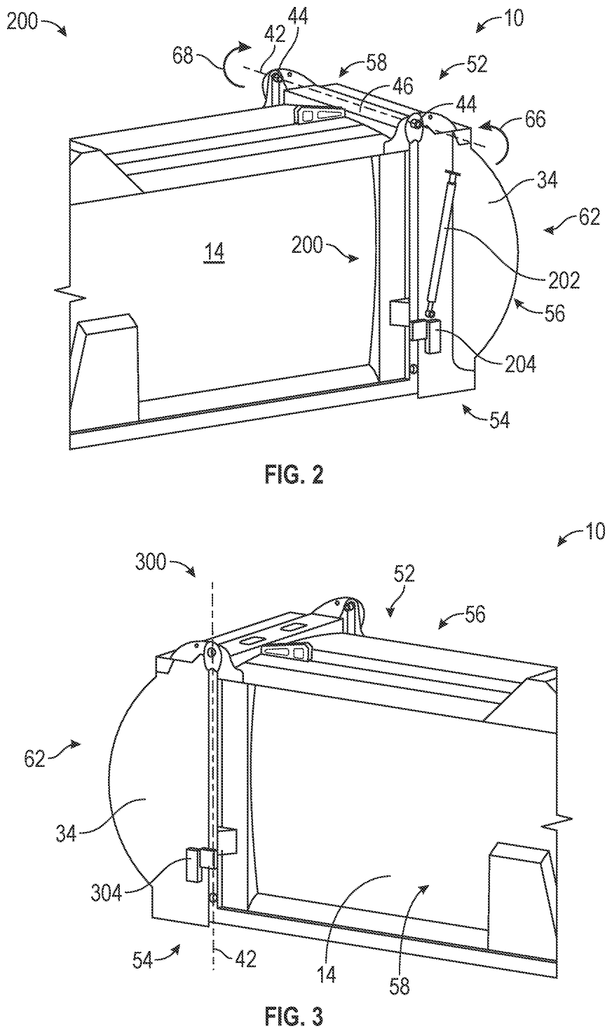

Referring particularly to FIG. 2, tailgate 34 can be rotatably or pivotally coupled with refuse compartment 30 or body 14 at an upper edge or upper portion 46 of body 14. Tailgate 34 may be rotatably or pivotally coupled with refuse compartment 30 through hinges 44. Hinges 44 can be positioned at opposite lateral ends of body 14.

Body 14 may define or include a top side 52, a bottom side 54, a left side 56, a right side 58, and a rear 62 of refuse vehicle 10. Tailgate 34 is pivotally coupled with body 14 at a rearwards position relative to body 14. In some embodiments, left side 56 is a left lateral side of refuse vehicle 10 and right side 58 is a right lateral side of refuse vehicle 10. Rear 62 of refuse vehicle 10 or body 14 may be a rear longitudinal end. Likewise, refuse vehicle 10 includes a front 64 that may be a front longitudinal end of refuse vehicle 10 (shown in FIG. 1).

Hinges 44 can be positioned at opposite lateral sides or ends of body 14 along upper portion 46 of body 14. For example, a first hinge 44 may be positioned at right side 58 of body 14, while a second hinge 44 can be positioned at left side 56 of body 14. Hinges 44 can pivotally couple body 14 with tailgate 34 and may define an axis 42 extending therethrough. In some embodiments, axis 42 extends in a lateral direction. In some embodiments, axis 42 is parallel with upper portion 46 of body 14. Tailgate 34 may be driven to pivot or rotate about axis 42 relative to body 14 in direction 66 to transition from the first position (as shown in FIG. 2) to the second position (to facilitate access to refuse compartment 30 or an inner volume of body 14. After tailgate 34 has been transitioned out of the first position into the second position, tailgate 34 can be re-transitioned into the first position from the second position by rotation or pivoting of tailgate 34 about axis 42 in a direction 68 that is opposite direction 66.

### Tailgate with Electric Linear Actuators

Referring still to FIG. 2, the tailgate 34 of the refuse vehicle 10 can include an electric apparatus, assembly, drive assembly, a tailgate actuator assembly, a fully electric tailgate actuator assembly, etc., shown as electric apparatus 200. Electric apparatus 200 includes an electric device, shown as electric actuator 202, to facilitate, along with electric motor 204, at least one of movement, rotation, pivoting, swinging, etc., of the tailgate 34 about axis 42. In some embodiments, the tailgate 34 includes a number of the electric actuators 202 to facilitate movement of the tailgate 34 in one or more directions (e.g., in direction 66 and/or direction 68) at a variety of speeds (e.g., a constant angular speed, a non-constant angular speed, etc.). In some embodiments, the electric actuator 202 is a different electric device (e.g., motor, solenoid, etc.). For example, the electric actuator 202 may be ball screw driven by an electric motor. In some embodiments, the electric actuator 202 is replaced or augmented by an electric device (e.g., an electric motor) producing a rotational force instead of a linear force. In some embodiments, the tailgate 34 includes an eccentric gearbox driven by an electric motor to facilitate movement of the tailgate 34. For example, the electric actuator 202 could be an electric motor integrated with the axis 42 and configured to generate a rotational force (e.g., a torque) to facilitate opening of the tailgate 34. In some embodiments, the electric actuator is coupled to, or integrated with, a mechanical element. For example, the electric actuator 202 may be paired with a torsional spring to assist in opening the tailgate 34, similar to opening a garage door. Pairing the electric actuator 202 with one or more mechanical elements may reduce the “breakaway torque,” or the torque required by the electric actuator 202 to begin moving the tailgate 34 or other component. Additionally or alternatively, the tailgate 34 may include one or more electric components coupled to or integrated with traditional components of refuse vehicle 10. For example, an electrically controlled hydraulic swash plate could be coupled to one or more electronic sensors to throttle the flow of hydraulic fluid in a hydraulic system.

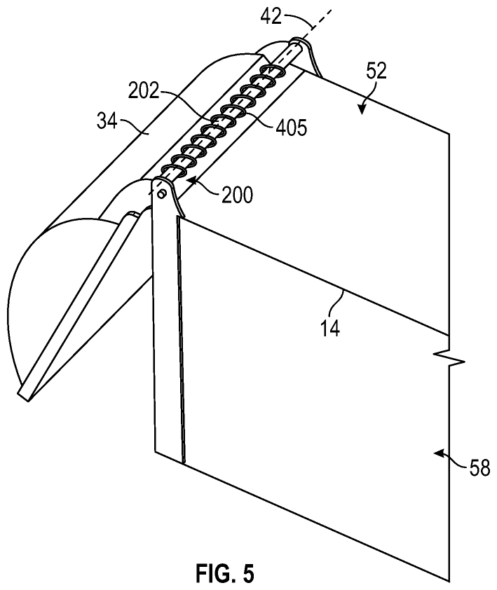

In some embodiments, the axis 42 is a horizontal axis located substantially at the rearward top edge of the refuse compartment 30 such that the tailgate 34 opens similarly to a hatch-type door. In some embodiments, such as the embodiment described below with reference to FIG. 5, the axis 42 is located elsewhere. The axis 42 may be or include one or more mechanical bearings, for example a hinge. In some embodiments, the axis 42 couples the tailgate 34 to the body 14 via one or more removable elements, such as a removable pin. The removable element may allow the tailgate 34 to be removed from the body 14 and/or replaced by another tailgate. For example, the tailgate 34 may include one or more battery systems (e.g., energy storage and/or generation system 20) that may be replaced when the battery system is depleted by swapping the tailgate for a different tailgate having a charged battery system.

In some embodiments, the tailgate 34 includes one or more additional electric components. For example, the tailgate 34 may include one or more electric locks as described in detail with reference to FIG. 3. Additionally or alternatively, the tailgate 34 may include one or more electric packing mechanisms. For example, the tailgate 34 may include an electrically driven pendulum packer. A rack may be coupled to the base of a pendulum packer and be driven by an electric motor coupled to a sun gear received by the rack. The electric motor may impart potential energy on the pendulum packer by lifting/rotating the pendulum packer into a raised position (e.g., by driving the sun gear). The pendulum packer may freely pivot/fall from the raised position thereby converting the potential energy into kinetic energy used to compress refuse. In some embodiments, compression of the pendulum packer is provided in whole or in part by an electric device (e.g., an electric motor). For example, an electric motor may drive the pendulum packer through a series of gears to provide a large compressive force. In some embodiments, the tailgate 34 includes a linear electric packing mechanism. For example, one or more gear racks may couple to an inside surface of the refuse compartment 30 and receive a pinion gear coupled to an electric device (e.g., a motor) of the tailgate 34 configured to translate a packer component horizontally across the refuse compartment 30 thereby packing the refuse therein.

In some embodiments, the tailgate 34 includes one or more electric components to facilitate ejection of refuse from the refuse compartment 30. For example, one or more gear racks may couple to a surface of the refuse compartment 30 and/or tailgate 34 to receive one or more electrically driven pinion gears to translate an ejector component of the refuse compartment 30 to enable ejection of refuse. In some embodiments, one or more gear racks may couple to the bottom of the refuse compartment 30 while in other embodiments the one or more gear racks may couple to the sides of the refuse compartment 30 (e.g., to the body 14). Alternatively or additionally, one or more gear racks may couple to an ejector component and be driven by an electric device coupled to the body 14 of refuse vehicle 10.

As shown in FIG. 3, the tailgate 34 of the refuse vehicle 10 includes a locking system 300 (e.g., a lock, a fully electric lock, etc.) that includes one or more electric locks 304. The electric locks 304 may selectively couple the tailgate 34 to the body 14 of the refuse vehicle 10. Additionally or alternatively, the electric locks 304 may selectively hold the tailgate 34 in an open or closed position. For example, a top portion of the tailgate 34 is coupled to the body 14 via the axis 42 (as described in detail with reference to FIG. 2), while a bottom portion of the tailgate 34 is selectively coupled to the body 14 via the electric locks 304, disengagement of which allows the tailgate 34 to open (e.g., to transition out of the first position and into the second position). The electric locks 304 are shown on the bottom of the tailgate 34, however in some embodiments the electric locks 304 are located elsewhere, for example on the side of the tailgate 34. The electric locks 304 may include one or more pins. The one or more pins may be received by one or more coupling elements of the body 14 and/or the frame 12. In some embodiments, the electric locks 304 include an electric device (e.g., a solenoid, electromagnetic actuator, ball screw driven by an electric motor, etc.) to translate the one or more pins between a locked and unlocked position. In some embodiments, the electric locks 304 include a different electric device. Additionally or alternatively, the electric locks 304 may electromagnets. For example, electromagnetic locks may selectively secure the tailgate 34 to the body 14 by magnetizing and demagnetizing.

In some embodiments, the electric locks 304 coordinate with one or more other components of the tailgate 34 (e.g., electric actuator 202, etc.) to facilitate opening and/or closing of the tailgate 34. For example, to open a hatch-type tailgate, the electric locks 304 may power a solenoid to disengage one or more pins from the body 14 and the electric actuator 202 may extend to rotationally open the tailgate 34 along the axis 42. Similarly, the electric actuator 202 (and/or any other actuator described herein) can, upon placing the tailgate 34 in the second position, continue to move and/or push at least a portion of the tailgate 34. The actuator 202 moving the tailgate 34 can reengage the one or more pins from the body 12 with the electric locks 304. Continuing the example, the electric locks 304 may further power a different solenoid to engage one or more additional pins to hold the tailgate 34 in an open position. In some embodiments, the tailgate 34 includes one or more sensors to determine a position (e.g., open, close) of the tailgate 34. Additionally or alternatively, the tailgate 34 may include one or more control circuits (e.g., a processor, FPGA, SOC, etc.) to determine a position of the tailgate 34. For example, a control circuit may read the current supplied to an electric actuator of the tailgate 34 to determine a position of the tailgate 34 based on the current load of the electric actuator.

As shown in FIG. 3, the axis 42 may be located on a side of the tailgate 34. In some embodiments, the axis 42 is on a right side or a left side of the tailgate 34. In some embodiments, the axis 42 is on both sides of the tailgate 34, facilitating opening of the tailgate to both sides. Additionally or alternatively, the tailgate 34 may be divided and open in a double-leafed manner. In some embodiments, each section of a divided tailgate may independently couple/decoupled from the body 14, allowing a section of the tailgate 34 to be replaced without replacing the entire tailgate. A divided tailgate allows for customization of the refuse vehicle 10. For example, a refuse vehicle may have a curbside section of the tailgate 34 with various curbside components (e.g., a grabber, tools, etc.) and a street-side section of the tailgate 34 with a high-visibility sign. It should be understood that the tailgate 34 may have, integrate, or otherwise utilize any of the components or features described herein. For example, the tailgate 34 having an axis 42 on the side of the tailgate 34 may include any of the electric components (e.g., electric actuator 202) described in reference to FIG. 2, to facilitate opening of the tailgate 34. Furthermore, failure to mention a specific component does not preclude integration of such a component. The tailgate 34 described herein may include any component known in the art.

FIG. 4 depicts a top right view of the refuse vehicle 10 including the electric apparatus 200. The electric apparatus 200 can include at least one spring 405 and/or spring mechanism 405. The spring mechanism 405 can be or include a torsional spring. The spring mechanism 405 can be or include at least one of a mechanical coil spring and/or a gas spring. The spring mechanism 405 can assist the actuator 202 in opening and/or closing the tailgate 34. The spring mechanism 405 can reduce the torque required by actuator 202 to begin moving the tailgate 34 and/or other components described herein.

The actuator 202 and/or the spring mechanism 405 can produce a linear force that moves the tailgate 34 from the first position (similar to the position shown in FIG. 2) to the second position (similar to the one shown in FIG. 4). Similarly, the actuator 202 and/or spring mechanism 405 can produce a rotational force that moves the tailgate 34 from the first position to the second position. FIG. 4 depicts an example of the actuator 202 along with the spring mechanism 405 producing a linear force to move the tailgate 34 from the first position to the second position.

FIG. 5 depicts a top right view of the refuse vehicle 10 including the spring mechanism 405. The spring mechanism 405 has been disposed between the tailgate 34 and body 14. The spring mechanism 405 can, with the spring mechanism 405 disposed between the tailgate 34 and the body 14, produce a rotational force that moves the tailgate 34 from the first position to the second position. FIG. 5 depicts an example of the spring mechanism 405 producing a rotational force to move the tailgate 34 from the first position to the second position.

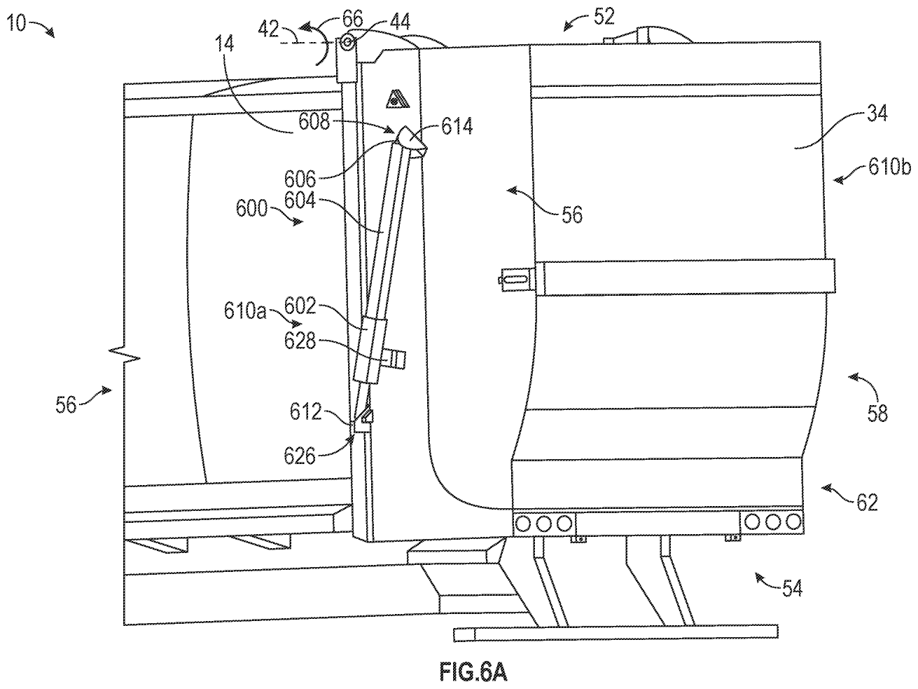

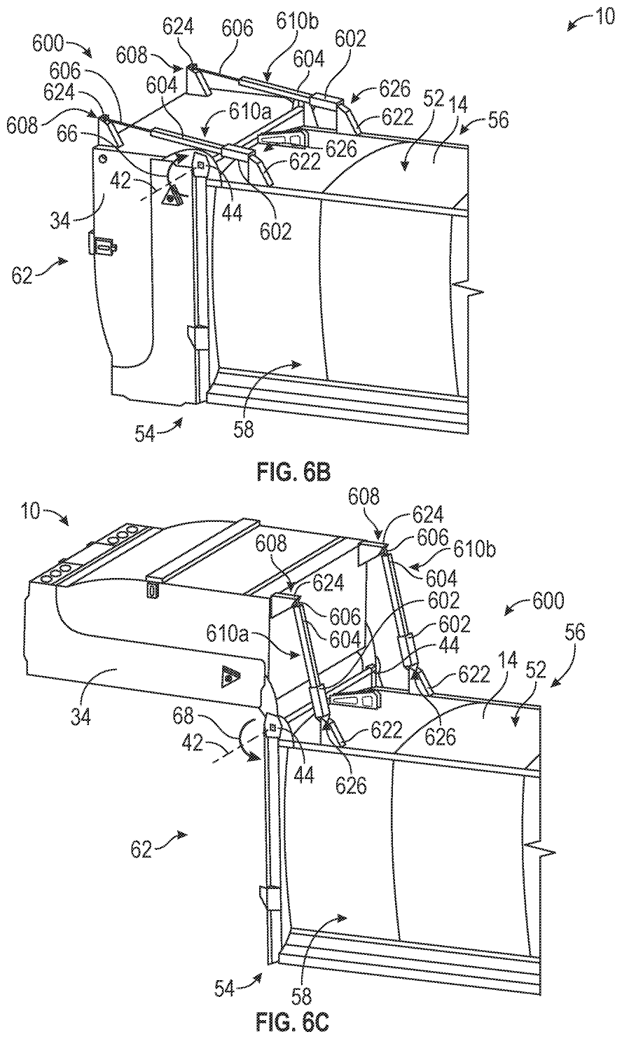

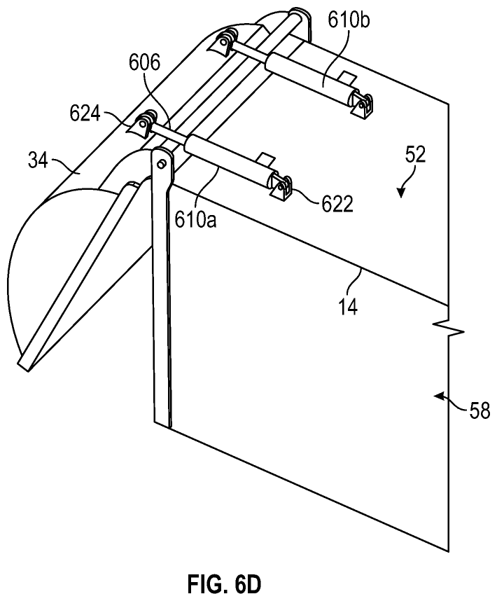

Referring particularly to FIGS. 6A-6D, various embodiments of an electric lift mechanism 600 (e.g., a fully electric tailgate actuator assembly) are shown. Electric lift mechanism 600 is configured to drive, rotate, move, pivot, etc., tailgate 34 of refuse vehicle 10 about axis 42 to transition the tailgate 34 between the first position (shown in FIG. 6A) and the second position (shown in FIG. 6C). Advantageously, electric lift mechanism 600 may use electrical energy to facilitate an efficient, robust, and environmentally friendly apparatus to transition tailgate 34 between the first position and the second position.

Referring particularly to FIGS. 6A-6C, electric lift mechanism 600 includes a pair of linear electric actuators 610 (e.g., linear electric actuator 610a and linear electric actuator 610b). Linear electric actuators 610 can be configured to consume electrical energy (e.g., as provided by the energy storage and/or generation system 20 of refuse vehicle 10) to output translational motion or a translational force (e.g., to extend or retract). Linear electric actuators 610 can include an outer member 604 and an inner member 606. Outer member 604 can be configured to receive the inner member 606 so that inner member 606 translates (e.g., extends or retracts) relative to outer member 604. Linear electric actuators 610 each include an electric motor 602 that is configured to drive inner member 606 to translate in a first direction (e.g., to extend linear electric actuator 610) or in a second direction (e.g., to retract linear electric actuator 610) relative to outer member 604. Linear electric actuators 610 each include a first end 608 and a second end 626. In some embodiments, first end 608 of linear electric actuator 610 is a distal end of inner member 606.

Referring particularly to FIG. 6A, linear electric actuators 610 can be positioned on opposite lateral sides of refuse vehicle 10. For example, a first linear electric actuator 610a is positioned on left side 56 of refuse vehicle 10, while a second linear electric actuator 610b is positioned on right side 58 of refuse vehicle 10. First linear electric actuator 610a is configured to pivotally or rotatably couple with left side 56 of body 14 at second end 626 and pivotally or rotatably couple with left side 56 of tailgate 34 at first end 608. Likewise, second linear electric actuator 610b is configured to pivotally or rotatably couple with right side 58 of body 14 at second end 626 and pivotally or rotatably couple with right side 58 of tailgate 34 at first end 608.

Body 14 can include a mount 612 that is configured to rotatably or pivotally couple with second end 626 of first linear electric actuator 610a. Mount 612 can be positioned along a frame member of body 14 on the left side 56 of body 14, proximate bottom side 54 of body 14. Tailgate 34 includes a mount 414 that is configured to pivotally or rotatably couple with first end 608 of linear electric actuator 610a. In some embodiments, mount 614 is positioned on left side 56 of tailgate 34 proximate top side 52 of tailgate 34. It should be understood that second linear electric actuator 610b can be similarly configured on right side 58 of refuse vehicle 10 and may include corresponding and symmetrically positioned/configured mounts 612 and 614.

First linear electric actuator 610a and second linear electric actuator 610b can operate in unison to extend or retract to drive tailgate 34 to pivot about axis 42. For example, first linear electric actuator 610a and second linear electric actuator 610b can operate in unison to extend to drive tailgate 34 to pivot about axis 42 in direction 66 to transition tailgate 34 out of the first position and into the second position. Once tailgate 34 is transitioned into the second position, first linear electric actuator 610a and second linear electric actuator 610b can maintain a current degree of extension to maintain tailgate 34 in the second position. Tailgate 34 can be transitioned out of the second position and into the first position by operation of first linear electric actuator 610a and second linear electric actuator 610b to retract. Retraction of first linear electric actuator 610a and second linear electric actuator 610b (e.g., in unison) drives tailgate 34 to rotate or pivot about axis 42 relative to body 14 in direction 68.

First linear electric actuator 610a and second linear electric actuator 610b can each include a brake 628. In some embodiments, brake 628 is an electrically actuated brake that is configured to transition between a locked position and an unlocked position. When brake 628 is transitioned into the locked position, brake 628 may engage a mechanism of the corresponding linear electric actuator 610 to prevent or limit translation of inner member 606 relative to outer member 604 or to otherwise lock linear electric actuator 610 at a current degree of extension or retraction.

First linear electric actuator 610a and second linear electric actuator 610b can be electrically driven ball-screw actuators, including a ball screw mechanism that is configured to receive rotational kinetic energy from electric motor 602 and transfer the rotational kinetic energy received from electric motor 602 to translational motion between inner member 606 and outer member 604. In some embodiments, brake 628 is configured to transition into the locked position to engage the ball screw mechanism to lock linear electric actuator 610 at a current degree of extension or retraction (e.g., to limit extension or retraction of linear electric actuator 610).

Referring particularly to FIGS. 6B-6C, first linear electric actuator 610a and second linear electric actuator 610b can be positioned on top side 52 of refuse vehicle 10. For example, body 14 can include mounts 622 that extend, protrude, etc., from top side 52 of refuse vehicle 10. Mounts 622 can be configured to receive and pivotally or rotatably couple with second ends 626 of linear electric actuators 610. Mounts 622 may be positioned on top side 52 of body 14 at left side 56 and ride side 58 of body 14. Tailgate 34 includes mounts 624 that extend from top side 52 of tailgate 34. Mounts 624 are each configured to receive and pivotally couple with the distal end of a corresponding one of inner members 606. In some embodiments, mounts 624 pivotally or rotatably couple with first ends 608 of linear electric actuators 610.

First linear electric actuator 610a and second linear electric actuator 610b can be configured to retract (e.g., in unison) to drive tailgate 34 to pivot about axis 42 (e.g., in direction 66) to thereby transition tailgate 34 out of the first position (shown in FIG. 6B) to the second position (shown in FIG. 6C). First linear electric actuator 610a and second linear electric actuator 610b can be configured to extend (e.g., in unison) to drive tailgate 34 to pivot about axis 42 (e.g., in direction 68) to transition tailgate 34 out of the second position (shown in FIG. 6C) to the first position (shown in FIG. 6B). First linear electric actuator 610a and second linear electric actuator 610b can include brake 628 that is configured to limit extension/retraction of first linear electric actuator 610a and second linear electric actuator 610b, and thereby limit rotation of tailgate 34 about axis 42.

In some embodiments, any of the linear electric actuators described herein (e.g., linear electric actuators 610, electric actuators 202, etc.) may be replaced with hydraulic actuators (e.g., hydraulic linear actuators). The hydraulic actuators may receive pressurized hydraulic fluid to operate to extend or retract. The hydraulic fluid can be pressurized by a pump that is driven by one or more electric motors. In this way, the tailgate 34 may be configured to be transitioned between the first position and the second position using a hydraulic-electric hybrid system.

FIG. 6D depicts a top right view of the vehicle 10 including the linear electric actuators 610a and 610b. The linear electric actuators 610a and 610b are disposed on the top side 52 of the vehicle 10. As shown in FIG. 6D the linear electric actuators 610a and 610b having been at least one of mounted, placed, secured, attached and/or otherwise coupled with the vehicle 10 on the top side 52. Similarly, the linear electric actuators 610a and 610b have been located closer to a center line of the top side 52 in relation to the location of the linear actuators 610a and 610 in FIG. 6B. The placement of the linear electric actuators 610a and 610b (as shown in FIG. 6D) can provide protection for the linear electric actuators 610a and 610b by providing additional distance between the actuators 610a and 610b and the outer portion of the top surface 52. Similarly, the mounts 622 and 624 have also been move closer to the center line of the top surface 52 and further away from the outer portion of the tailgate 34 and/or the top surface 52.

### Cable Lift

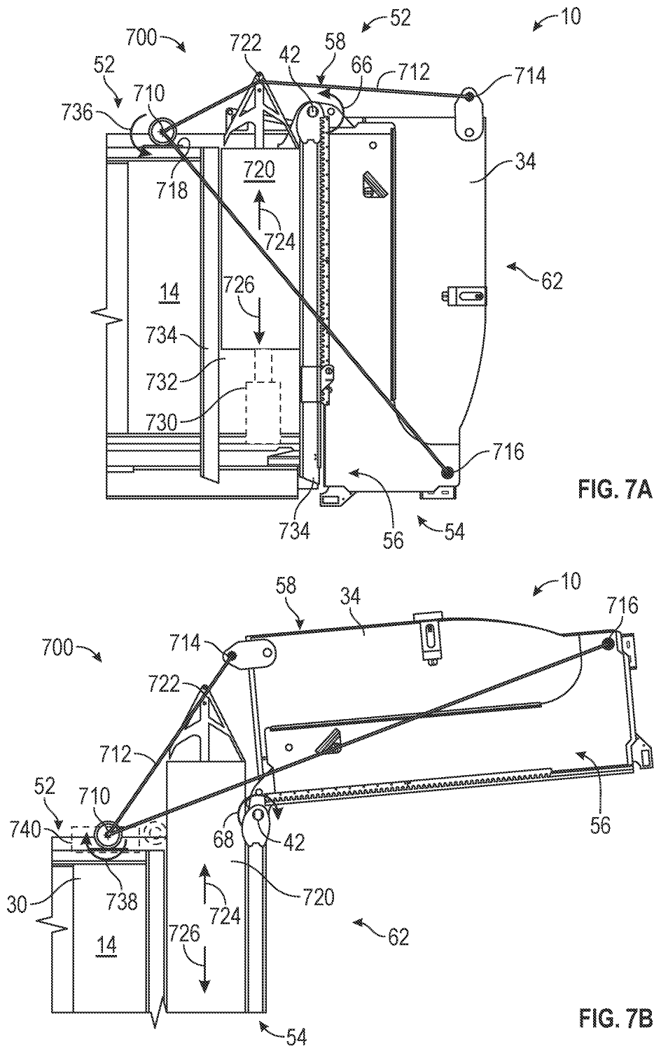

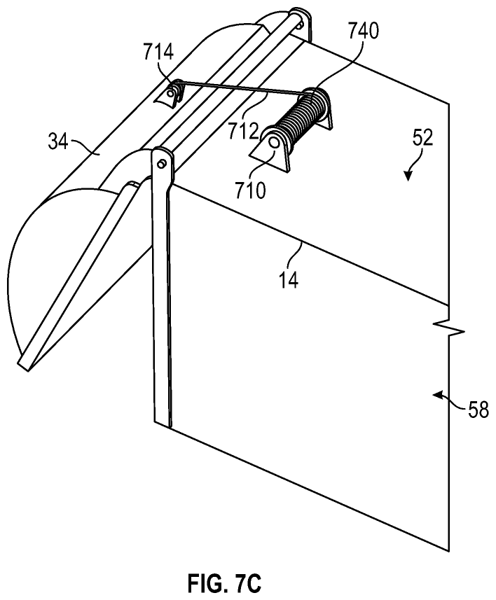

Referring particularly to FIGS. 7A-7B, tailgate 34 may be configured to be driven to pivot or rotate about axis 42 (e.g., between the first position shown in FIG. 7A and the second position shown in FIG. 7B) by a winch or cable lift mechanism 700 (e.g., a tailgate actuator assembly, a fully electric tailgate actuator assembly, etc.). Cable lift mechanism 700 includes a winch 710, a cable 712, and a slidable member 720. In some embodiments, slidable member 720 is received within a corresponding track, groove, recess, etc., shown as track 732 of body 14. Track 732 may be a vertical track that extends along a side of body 14. In some embodiments, track 732 is defined by a vertical members 734 (e.g., beams, bars, elongated members, I-beams, etc.). Winch 710 may be fixedly coupled or otherwise mounted at a top surface of body 14.

Slidable member 720 can include a body portion that is configured to slidably engage or slidably couple with vertical members 734 of track 732 and an engagement portion 722 (e.g., an extension, a protrusion, etc.) that protrudes from an upper portion of the body portion. Tailgate 34 includes an engagement portion 714 at an upper rear corner of tailgate 34. In some embodiments, engagement portion 714 is positioned at or defines a corner of tailgate 34 that is proximate top side 52 and rear 62 of tailgate 34. Engagement portion 714 can include an aperture, an opening, an eyelet, etc., configured to receive a first end of cable 712. In some embodiments, engagement portion 714 extends outwards or upwards from an upper surface of tailgate 34.

Tailgate 34 also includes a bottom receiving portion 716. Receiving portion 716 can be or include a post, a protrusion, a hook, an eyelet, an aperture, an opening, etc., configured to couple with a second or opposite end of cable 712. Cable 712 may couple at the second end with receiving portion 716, engage or wrap around winch 710, engage or pass over engagement portion 722, and couple with engagement portion 714 of tailgate 34 at the first end. Receiving portion 716 can be the same as or similar to engagement portion 714. Receiving portion 716 is positioned at a bottom rear corner of tailgate 34 and may be vertically aligned or offset from engagement portion 714. For example, the second end of cable 712 can be coupled with tailgate 34 at a corner of tailgate 34 that is proximate bottom side 54 and rear 62 of tailgate 34.

Winch 710 can be driven to rotate to drive cable 712 to transition tailgate 34 between the first position (shown in FIG. 7A) and the second position (shown in FIG. 7B). Winch 710 can include an electric motor 740 that is configured to drive winch 710 to rotate in direction 736 (e.g., to transition tailgate 34 from the first position shown in FIG. 7A to the second position shown in FIG. 7B) or in direction 738 (e.g., to transition tailgate 34 from the second position shown in FIG. 7B to the first position shown in FIG. 7A).

When winch 710 operates to rotate in direction 736, a tensile or pulling force is applied to engagement portion 714 through portions of cable 712 that extend from winch 710, over engagement portion 722, and to receiving portion 714. The tensile or pulling force results in a moment about axis 42 in direction 66, thereby driving tailgate 34 to rotate in direction 66 about axis 42 (e.g., to transition out of the first position and into the second position). Winch 710 may operate to rotate or be driven to rotate in direction 738 at a controlled speed. For example, weight of tailgate 34 and engagement of cable 712 between winch 710 and tailgate 34 may drive winch 710 to rotate in direction 738. Winch 710 may rotate (e.g., by back-driving motor 740) in direction 738 at a controlled speed to control a rotational speed of tailgate 34 about axis 42 in direction 68.

Referring still to FIGS. 7A and 7B, slidable member 720 may be configured to translate in direction 524 (e.g., upwards) or direction 726 (e.g., downwards) along track 732 to facilitate an improved mechanical advantage or lever arm of winch 710. For example, slidable member 720 can translate in direction 524 (upwards) when winch 710 operates to transition tailgate 34 from the first position to the second position to thereby improve a mechanical advantage of winch 710. Likewise, slidable member 720 can translate in direction 726 when winch 710 operates to transition tailgate 34 from the second position to the first position to thereby improve the mechanical advantage of winch 710.

Slidable member 720 can be independently driven to translate along track 732. For example, slidable member 720 may be driven to translate along track 732 in direction 524 or direction 726 by operation of a linear electric actuator 530. In other embodiments, slidable member 720 is driven to translate in direction 524 or direction 726 through operation of winch 710 (e.g., through a gear set, a rack and pinion, etc.). Advantageously, slidable member 720 improves a mechanical advantage of winch 710 so that efficiency of winch 710 is improved and a smaller or less powerful electric motor can be used to drive winch 710 to transition tailgate 34 between the first position and the second position.

FIG. 7C depicts a top right view of the vehicle 10. The vehicle 10 can include the cable lift mechanism 700. The cable lift mechanism 700 can include the winch 710, the cable 712, engagement portion 714, and the motor 740. The winch 710 can be disposed on and/or near a center line of the top surface 52. FIG. 7C depicts an example of the winch 710 disposed near the center line of the top surface 52. Similarly, the engagement portion 714 can be disposed on center line of the tailgate 34 that corresponds to and/or that lines up with the center line of the top surface 52. FIG. 7C depicts an example of the engagement portion 714 disposed on the center line of the tailgate 34. The placement of the winch 710 results in an increase of a distance between the winch 710 and the outer portion of the top surface 52. Similarly, the placement of the engagement portion 714 results in an increase of a distance between the engagement portion 714 and the outer portion of the tailgate 34.

### Eccentric Gear Mechanism

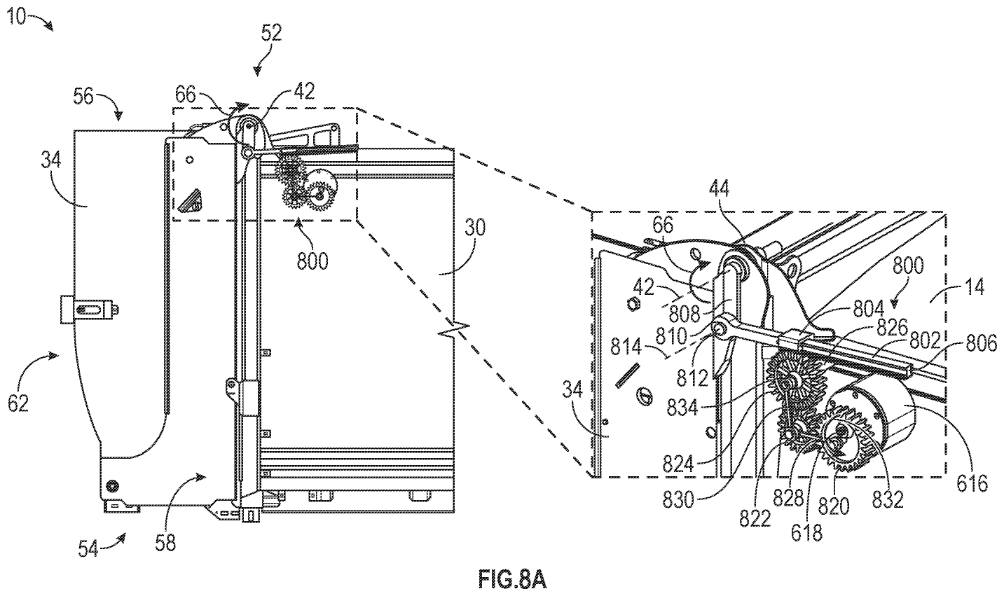

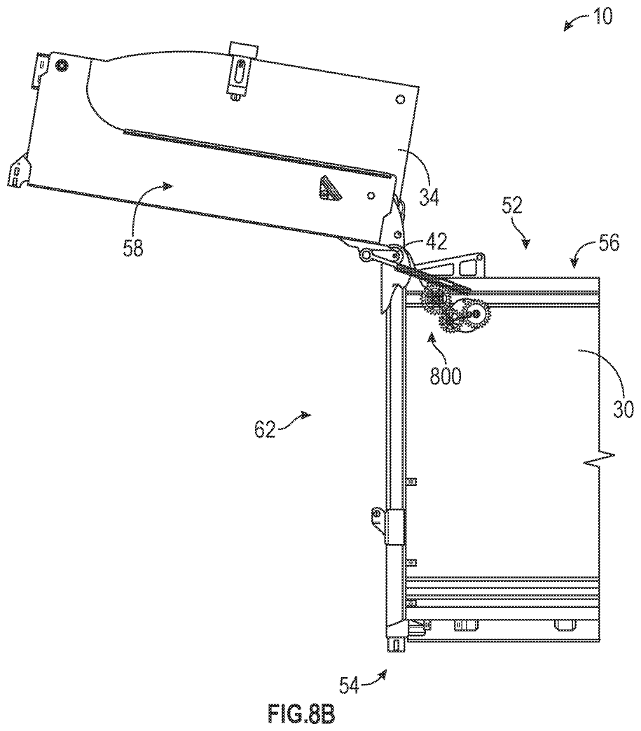

Referring particularly to FIGS. 8A-8B, tailgate 34 may be driven to transition between the first position and the second position by at least one eccentric gear mechanism 800 (e.g., a tailgate actuator assembly, a fully electric tailgate actuator assembly, etc.). The eccentric gear mechanism 800 can be including and/or enclosed in a gearbox. The eccentric gear mechanism 800 can be placed, attached, mounted, secured and/or couple with at least one side of the vehicle 10. FIG. 8A depicts an example of the gear mechanism coupled with the top side 52. Similarly, a first eccentric gear mechanism 800 can be coupled with the vehicle 10 on the top side 52 near the right side 58 and a second eccentric gear mechanism 800 can be coupled with the vehicle 10 on the top side near 52 near the left side 56. The eccentric gear mechanism 800 can be or include a damper system that can absorb force placed on the vehicle 10 and/or force placed on the tailgate 34.

The Eccentric gear mechanism 800 includes an electric motor 816, a first gear 820, a second gear 822, a third gear 824, a rack member 802, and a linkage 808. Electric motor 816 is fixedly coupled with body 14 and is configured to output mechanical energy or torque through a driveshaft 818. First gear 820 is rotatably or pivotally coupled with the driveshaft 818 at an off-centered position so that first gear 820 rotates relative to an off-centered position as electric motor 816 operates to drive driveshaft 818.

First gear 820 engages or meshes with second gear 822 so that rotation of first gear 820 about the off-centered position or axis drives second gear 822 to rotate. A relative distance between first gear 820 and second may be constant through a first linkage 828 that extends between a center of first gear 820 and a center of second gear 822. First linkage 828 can be rotatably or pivotally coupled with first gear 820 and second gear 822 at opposite ends so that first linkage 828 is free to rotate or pivot relative to first gear 820 and second gear 822, while maintaining a relative spatial distance between first gear 820 and second gear 822.

Second gear 822 engages or meshes with third gear 824 so that rotation of second gear 822 drives rotation of third gear 824. A second linkage 830 that may be similar to first linkage 828 extends between second gear 822 and third gear 824 and pivotally or rotatably couples at opposite ends with second gear 822 and third gear 824. Second linkage 830 facilitates maintaining a constant relative spatial distance between second gear 822 and third gear 824 as second gear 822 and third gear 824 are driven to rotate.

Third gear 824 engages or meshes with teeth of rack 802 so that rotation of third gear 824 drives translation of rack 802. Rack 802 may be received within a carrier member 826 that includes an engagement portion 804 and a shaft portion 834. Third gear 824 is rotatably or fixedly coupled with shaft portion 834 of carrier member 826. Carrier member 826 includes engagement portion 804 that is configured to engage or slidably couple with tracks 806 of rack 802. In some embodiments, rack 802 is configured to translate or slide relative to carrier member 826. Tracks 806 extend along a length of rack 802 and are configured to receive corresponding protrusions, engagement portions, fingers, etc., of engagement portion 804 of carrier member 826. Carrier member 826 may be spatially fixedly coupled with body 14 and rotatably or pivotally free relative to body 14 so that carrier member 826 rotates about an axis extending through shaft portion 834.

Rack 802 includes an end 810 that is configured to rotatably or pivotally couple with linkage 808. In some embodiments, end 810 includes an opening, bore, or aperture, that is configured to receive a pin 812 of linkage 808. Pin 812 may define an axis 814 about which rack 802 may rotate or pivot as tailgate 34 is driven to rotate about axis 42 between the first position and the second position. Linkage 808 may be fixedly coupled with tailgate 34 and rotatably coupled with hinge element 44 so that translation of rack 802 produces a torque about axis 42 to drive tailgate 34 to rotate about axis 42 between the first position and the second position.

When eccentric gear mechanism 800 operates to transition tailgate 34 out of the first position and into the second position (e.g., to open tailgate 34 or to drive tailgate 34 to pivot about axis 42 relative to body 14 in direction 66), electric motor 616 may drive first gear 620 to rotate about the off-centered position in direction 632 (e.g., in an anti-clockwise direction). Rotation of first gear 820 about the off-centered position in direction 832 drives rotation of second gear 822 in an opposite direction (e.g., a clockwise direction) while second gear 822 may spatially move or rotate relative to first gear 820 (e.g., while maintaining relative spatial distance equal to a length of first linkage 828).

Rotation of second gear 822 in the clockwise direction results in rotation of third gear 824 in an anti-clockwise direction, thereby driving rack 802 to translate. Rack 802 may translate due to the engagement between the teeth of rack 802 and third gear 824. Rack 802 translates to produce a moment about axis 42 in direction 66, thereby driving tailgate 34 to transition out of the first position and into the second position (shown in FIG. 8B). Electric motor may similarly operate in a direction opposite direction 832 to transition tailgate 34 out of the second position (shown in FIG. 8B) to the first position (shown in FIG. 8A).

### Side Hinge Tailgate

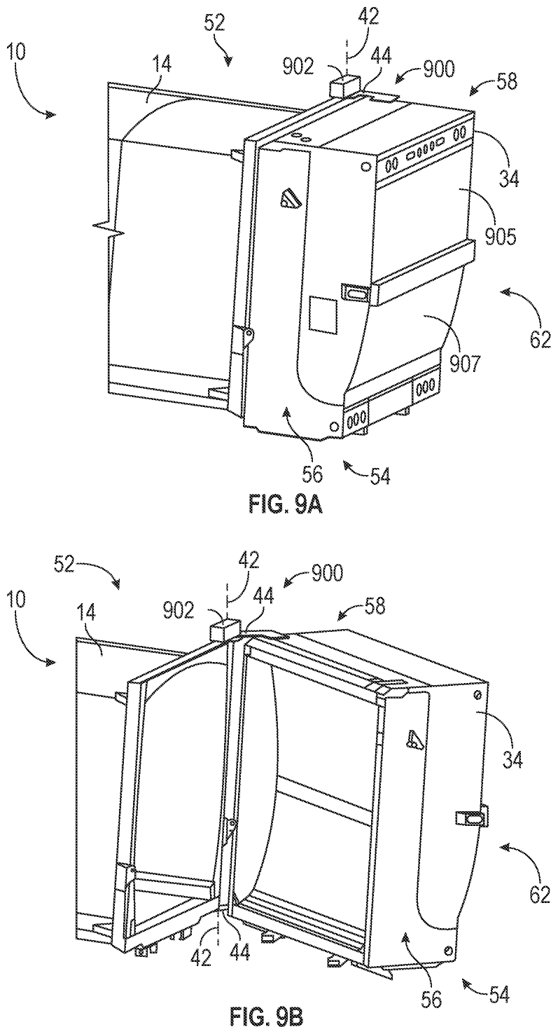

Referring particularly to FIGS. 9A and 9B, refuse vehicle 10 can include side-oriented hinges to rotatably or pivotally couple tailgate 34 with body 14 and a side-hinge mechanism 900 (e.g., a tailgate actuator assembly, a fully electric tailgate actuator assembly, etc.) configured to swing tailgate 34 relative to body 14. As shown in FIGS. 9A and 9B, hinge elements 44 are positioned along a lateral side at top and bottom of body 14, thereby defining axis 42 in a vertical direction.

Side-hinge mechanism 900 includes an electric motor 902 that is fixedly coupled at the upper side 52 of body 14. Electric motor 902 can be fixedly coupled with body 14 at an upper corner of body 14 proximate hinge elements 44 (e.g., an upper one of hinge elements 44). Electric motor 902 can include a gearbox or a gear ratio that outputs torque to rotate or pivot tailgate 34 about axis 42 between the first position (shown in FIG. 9A) and the second position (shown in FIG. 9B). Advantageously, since tailgate 34 is oriented to swing about a vertical axis between the first position and the second position, electric motor 902 may be sized to swing tailgate 34, without needing to lift tailgate 34 in a direction that opposes a direction of gravity.

The tailgate 34 can include at least one first portion 905 and at least one second portion 907. The first portion 905 and the second portion 907 can be mounted, placed, secured, attached and/or coupled with one another. The first portion 905 and the second portion 907 can move, while coupled with one another, in unison. For example, the first portion 905 and the second portion 907 can swing together as the tailgate 34 pivots about axis 42. The first portion 905 and the second portion 907 can also be decoupled from one another. The first portion 905 and the second portion 907 can, while decoupled from one another, move independent of each other. For example, the first portion 905 can pivot about axis 42 and move towards the left side 56 and the second portion 907 can pivot about the axis 42 and move towards the right side 58. The first portion 905 and the second portion 907 can also overlap one another. For example, the second portion 907 can move into the second position and the first portion 905 can then move to the second position responsive to the second portion 907 moving to the second position first. Similarly, the first portion 905 can move to the first position and the second position 907 can then move to the first position responsive to first portion 905 moving to the second position first.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A refuse vehicle, comprising:
a chassis;
a body coupled with the chassis, the body defining a refuse compartment;
a tailgate coupled with a rear of the body, the tailgate transitionable between a first position to limit access to the refuse compartment and a second position to allow access to the refuse compartment;
an electric tailgate actuator assembly comprising:
a first linkage extending from a first point on the body to a first point on the tailgate;
a second linkage extending from a second point on the body to a second point on the tailgate; and
an electric motor and a spring mechanism configured to drive at least one of the first linkage or the second linkage to transition the tailgate between the first position and the second position; and
a lock mechanism configured to lock the tailgate in the first position, wherein the lock mechanism is released as the tailgate rotates from the first position to the second position, and wherein the lock mechanism is engaged at a final stage as the tailgate rotates from the second position to the first position.

2. The refuse vehicle of claim 1, comprising:
the spring mechanism disposed on a lateral side of the body; and
the spring mechanism configured to produce a linear force to drive at least one of the first linkage or the second linkage to transition the tailgate between the first position and the second position.

3. The refuse vehicle of claim 1, comprising:
the spring mechanism disposed at least partially between the body and the tailgate; and
the spring mechanism configured to produce a rotational force to drive at least one of the first linkage or the second linkage to transition the tailgate between the first position and the second position.

4. The refuse vehicle of claim 1, comprising:
a top side of the body including:
a first mount to receive a first portion of the first linkage; and
a second mount to receive a first portion of the second linkage;
the first mount disposed at a first distance from a first lateral side of the body;
the second mount disposed at a second distance from a second lateral side of the body.

5. The refuse vehicle of claim 1, comprising:
the tailgate actuator assembly including a ball screw.

6. The refuse vehicle of claim 1, comprising:
a winch system disposed on the body and the winch system coupled with the tailgate; and
the winch system configured to assist the electric tailgate actuator assembly in transitioning the tailgate between the first position and the second position.

7. The refuse vehicle of claim 6, comprising:
the winch system disposed proximate to a center portion of a top side of the body.

8. The refuse vehicle of claim 1, comprising:
an eccentric gear linkage disposed on the body and the eccentric gear linkage coupled with the tailgate; and
the eccentric gear linkage configured to assist the electric tailgate actuator assembly in transitioning the tailgate between the first position and the second position.

9. The refuse vehicle of claim 1, comprising:
a hinge opening disposed on the body and the hinge opening coupled with the tailgate; and
the hinge opening configured to assist the electric tailgate actuator assembly in transitioning the tailgate between the first position and the second position.

10. A refuse vehicle, comprising:
a chassis;
a body coupled with the chassis, the body defining a refuse compartment;
a tailgate coupled with a rear of the body, the tailgate transitionable between a first position to limit access to the refuse compartment and a second position to allow access to the refuse compartment;
a fully electric tailgate actuator assembly comprising:
a first linkage extending from a first point on the body to a first point on the tailgate;
a second linkage extending from a second point on the body to a second point on the tailgate; and
an electric motor configured to drive at least one of the first linkage or the second linkage to transition the tailgate between the first position and the second position.

11. The refuse vehicle of claim 10, comprising:
a lock mechanism configured to lock the tailgate in the first position, wherein the lock mechanism is released as the tailgate rotates from the first position to the second position, and wherein the lock mechanism is engaged at a final stage as the tailgate rotates from the second position to the first position.

12. The refuse vehicle of claim 10, comprising:
a spring mechanism configured to work with the electric motor to drive at least one of the first linkage or the second linkage to transition the tailgate between the first position and the second position.

13. The refuse vehicle of claim 12, comprising:
the spring mechanism disposed on a lateral side of the body; and
the spring mechanism configured to produce a linear force to drive at least one of the first linkage or the second linkage to transition the tailgate between the first position and the second position.

14. The refuse vehicle of claim 12, comprising:
the spring mechanism disposed at least partially between the body and the tailgate; and
the spring mechanism configured to produce a rotational force to drive at least one of the first linkage or the second linkage to transition the tailgate between the first position and the second position.

15. The refuse vehicle of claim 10, comprising:
a top side of the body including:
a first mount to receive a first portion of the first linkage; and
a second mount to receive a first portion of the second linkage;
the first mount disposed at a first distance from a first lateral side of the body;
the second mount disposed at a second distance from a second lateral side of the body.

16. The refuse vehicle of claim 10, comprising:
the tailgate actuator assembly including a ball screw.

17. The refuse vehicle of claim 10, comprising:
a winch system disposed on the body and the winch system coupled with the tailgate; and
the winch system configured to assist the fully electric tailgate actuator assembly in transitioning the tailgate between the first position and the second position.

18. The refuse vehicle of claim 17, comprising:
the winch system disposed proximate to a center portion of a first side of the body.

19. The refuse vehicle of claim 10, comprising:
an eccentric gear linkage disposed on the body and the eccentric gear linkage coupled with the tailgate; and
the eccentric gear linkage configured to assist the fully electric tailgate actuator assembly in transitioning the tailgate between the first position and the second position.

20. A refuse vehicle comprising:
a chassis;
a body coupled with the chassis;
a tailgate coupled with the body, at least a portion of the tailgate transitionable between a first position and a second position; and
an actuator assembly comprising:
a first linkage extending from a first point on the body to a first point on the tailgate;
a second linkage extending from a second point on the body to a second point on the tailgate; and
an electric motor configured to drive at least one of the first linkage or the second linkage to transition the tailgate between the first position and the second position.
